(19) United States
(12) Patent Application Publication
(10) Pub. No.: US 2018/0043521 A1
(43) Pub. Date: Feb. 15, 2018

(54) SAFETY METHOD AND HANDHELD POWER TOOL

(71) Applicant: Hilti Aktiengesellschaft, Schaan, OT (LI)

(72) Inventors: Franz Moessnang, Stadtbergen (DE); Antonios Draganis, Bad Woerishofen (DE); Roland Schaer, Grabs (CH); Peter Hricko, Buchs (CH); Erwin Manschitz, Germering (DE); Bernd Gillmeier, Landsberg (DE)

(21) Appl. No.: 15/528,231

(22) PCT Filed: Nov. 17, 2015
(86) PCT No.: PCT/EP2015/076777

§ 371 Date: May 19, 2017

(30) Foreign Application Priority Data
Nov. 20, 2014 (EP) 14194078.3

(51) Int. Cl. B25F 5/02; B23Q 5/10; B23D 59/00

(52) U.S. Cl. CPC B25F 5/028; B23D 59/001; B23Q 5/10; B25D 2250/221

(57) ABSTRACT

A hand-held power tool (1) includes a tool holder (2) for holding a tool on a working axis (11) and a motor (5) for rotationally driving the tool holder (2) about the working axis (11). The motor (5) is situated in a power-tool housing (16) and a handle (9) is fastened on the power-tool housing (16) for guiding the hand-held power tool (1) during operation. A rotary motion sensor (15) detects a rotary motion of the power-tool housing (16) about the working axis (11). A monitor (19) ascertains a holding force based on an amplitude of the rotary motion in a frequency range between 0.4 Hz and 4 Hz. A safety device (13) reduces a torque output to the tool holder (2) when the detected rotary motion exceeds a limiting value, the limiting value being set as a function of the holding force.

### TECHNICAL FIELD OF THE INVENTION

The present invention relates to a control method for a hand-held power tool including a rotating tool, in particular a hammer drill or an electric screwdriver.

U.S. Pat. No. 7,552,781 discloses a hammer drill including an anti-kickback system. A rotational rate sensor determines, based on a displacement of a vibrating mass, a rotational speed of the electric screwdriver about a working axis. A safety function is activated based on the determined rotational speed. The safety function reduces the torque on the tool.

The triggering of the safety function is to take place in a reliable manner. In this case, both a triggering in the absence of potential danger to the user as well as a non-triggering in the presence of potential danger is to be avoided.

### SUMMARY OF THE INVENTION

The hand-held power tool according to the present invention includes a tool holder for holding a tool on a working axis and a motor for rotationally driving the tool holder about the working axis. The motor is situated in a power-tool housing and a handle is fastened on the power-tool housing for guiding the hand-held power tool during operation. A rotary motion sensor detects a rotary motion of the power-tool housing about the working axis. A monitor ascertains a holding force based on an amplitude of the rotary motion in a frequency range between 0.4 Hz and 4 Hz. A safety device reduces a torque output to the tool holder when the rotary motion exceeds a limiting value. The limiting value is established as a function of the holding force.

The safety device adapts its triggering behavior to an ascertained holding force of the user. The influence of the holding force on the mean motion of the hand-held power tool is not to be significantly differentiated from other influences on the mean motion. In particular, the various applications and associated different typical motions of one and the same hand-held power tool make it difficult to identify the holding force. According to the present invention, it has been found that, in a narrow frequency range, the rotary motion about the working axis is significant for the holding force.

### BRIEF DESCRIPTION OF THE DRAWINGS

The following description explains the present invention on the basis of exemplary specific embodiments and figures.

FIG. 1 shows a hammer drill; and

FIG. 2 shows a block diagram of a controller of the hammer drill.

Identical or functionally identical elements are indicated by identical reference numerals in the figures, unless indicated otherwise.

### DETAILED DESCRIPTION OF THE INVENTION

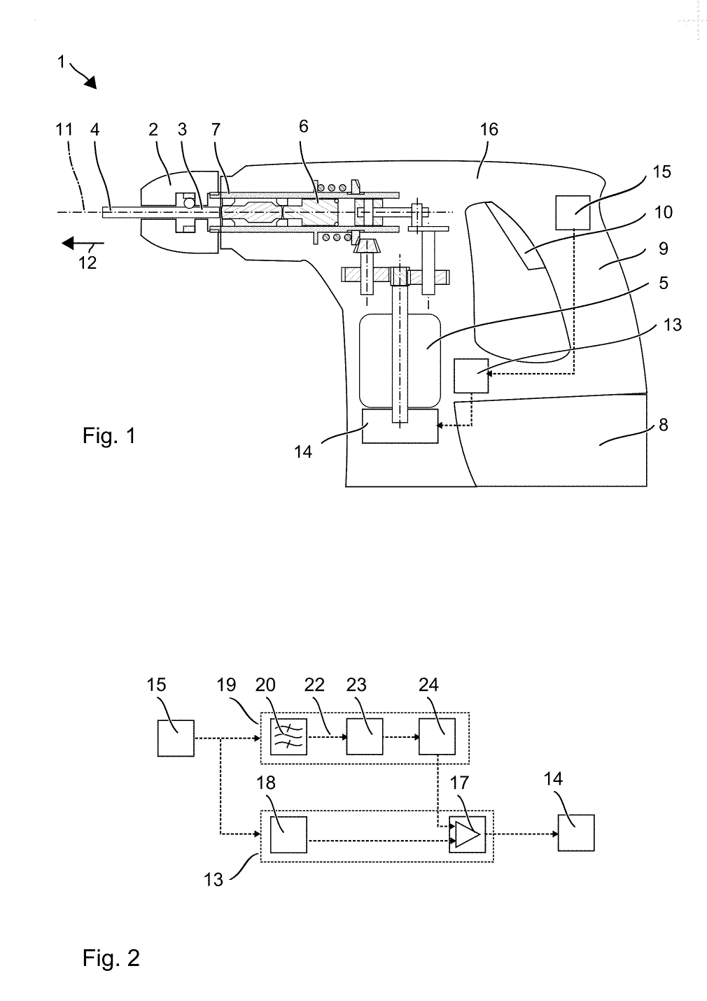

FIG. 1 shows a hammer drill 1 as an exemplary embodiment of a hand-held power tool. Hammer drill 1 includes a tool holder 2, into which a shaft end 3 of a tool, e.g., of drill bit 4, may be inserted. A motor 5, which drives a hammer mechanism 6 and an output shaft 7, forms one primary drive of hammer drill 1. A battery pack 8 or a mains power line supplies motor 5 with current. A user may guide hammer drill 1 with the aid of a handle 9 and may start hammer drill 1 with the aid of a main button 10. During operation, hammer drill 1 continuously rotates drill bit 4 about a working axis 11 and may thereby hammer drill bit 4 into a substrate in direction of impact 12 along working axis 11.

Hammer drill 1 includes a safety device 13, which protects the user against an excessive repercussive torque of drill bit 4. Hammer drill 1 exerts a repercussive torque onto the user, which results as a reaction to the torque transmitted by drill bit 4 onto the workpiece. Provided the substrate yields during drilling, the repercussive torque is uniform and low. In the event that a drill bit is jammed in the workpiece, a high repercussive torque results due to the abruptly braked rotating assemblies. The user is no longer able to sufficiently counteract this repercussive torque, and entire hammer drill 1, including handles 9, therefore begins to rotate about the rotational axis of drill bit 4. Safety device 13 monitors a rotary motion of handle 9 relative to working axis 11 and reduces the torque output to tool holder 2 if it is expected that the instantaneous rotary motion will result in a rotation of entire hammer drill 1 by a critical angle. The critical angle is, for example, 60 degrees. The reduction in the torque takes place, for example, by stopping motor 5 with the aid of a brake 14.

Safety device 13 detects the rotary motion of handle 9 with the aid of a rotary motion sensor 15. Rotary motion sensor 15 is, for example, a gyro sensor, which directly determines the angular velocity about working axis 11. The gyro sensor includes, e.g., an oscillatingly suspended chip. The Coriolis force associated with the rotary motion influences the oscillation frequency of the chip. On the basis of the oscillation frequency, rotary motion sensor 15 ascertains the angular velocity triggering the Coriolis force. Rotary motion sensor 15 may be situated in the vicinity of working axis 11 or offset with respect to working axis 11 in power-tool housing 16 or handle 9.

Safety device 13 evaluates the angular velocity and ascertains whether a user-endangering situation is present. One exemplary simple evaluation of safety device 13 is based on a comparator 17, which compares whether the angular velocity exceeds a limiting value for the angular velocity. In this case, safety device 13 triggers a suitable protective measure. For example, safety device 13 activates brake 14 of motor 5. Motor 5 is preferably braked to a standstill.

Another evaluation ascertains, for example, an instantaneous torsion angle of power-tool housing 16 with respect to a preceding point in time. An evaluation unit 18 integrates the angular velocity starting at the point in time. If the torsion angle exceeds a limiting value for the torsion angle, safety device 13 triggers the suitable protective measure.

Another evaluation unit 18 combines the instantaneous angular velocity and the instantaneous torsion angle. For example, a future torsion angle is estimated. The future torsion angle is the sum of the instantaneous torsion angle and the product of the instantaneous angular velocity and a fixed period of time of, e.g., 10 ms. The future torsion angle is compared with a limiting value for the future torsion angle and, if necessary, safety device 13 is triggered. Instead of ascertaining the future torsion angle, a table including pairs of limiting values for the angular velocity and the instantaneous torsion angle may be utilized. Safety device 13 is triggered when both limiting values of one pair are exceeded.

Safety device 13 ascertains the user behavior during on-going operation, also outside of a potentially critical situation. A monitor 19 ascertains the mean holding force which the user applies against a rotation of hammer drill 1 about working axis 11. The holding force of the user is primarily dependent on the user's physical strength, but also on the user's attentiveness, activity, the spatial orientation of hammer drill 1, etc. Drill bit 4, which rotates at a largely constant rotational speed and is acted upon by a largely constant number of strikes, generates vibrations in hammer drill 1 during drilling. The amplitude of the vibrations is dependent on the substrate, the tool, the contact pressure and the holding force of the user. Although a multitude of unknown variables affect the amplitude of the vibrations, there appears to be a dependence of the amplitude dominated by the holding force in a narrow frequency range about 2 Hz. Monitor 19 utilizes this dependence in order to ascertain a measure for the holding force. Monitor 19 contains a bandpass filter 20 having a mid-band frequency between 0.4 Hz and 4 Hz, to which measuring signal 21 of rotary motion sensor 15 is supplied. The amplitude of output signal 22 of bandpass filter 20 is detected as a measure for the holding force. For example, output signal 22 may be rectified in a rectifier 23. The rectified signal may be supplied to a discriminator 24 and may be assigned, for example, to one of three categories “weak holding force,” “mean holding force,” and “strong holding force.”

Safety device 13 triggers brake 14 as a function of the holding force. A user having a firm grip may probably also slow down a rapidly rotating hammer drill 1 before a critical angle is reached, as compared to a user having a less firm grip. Safety device 13 changes the limiting value of comparator 17 as a function of the ascertained holding force. For example, the limiting value for the “strong holding force” is set to be greater than for the “weak holding force.” Preferably, the limiting value increases constantly or incrementally as the holding force increases.

Brake 14 may be, for example, a mechanically acting brake, which clamps drill bit 4. Preferably, the drive train is decoupled in this case from motor 5 with the aid of a slipping clutch or an electrically activated clutch. According to one preferred embodiment, brake 14 is to be implemented together with motor 5. Motor 5 is switched into a generator mode and the generated electrical power is introduced into an ohmic resistor. Alternatively, a current may be supplied into motor 5, in particular in the case of a reluctance motor, in such a phase-controlled way that the electromechanical force counteracts the rotary motion of motor 5. The torque may also be reduced with the aid of an electrically controlled clutch.

What is claimed is:

1-5. (canceled)

6. A hand-held power tool comprising:
a tool holder for holding a tool on a working axis;
a motor for rotationally driving the tool holder about the working axis;
a power-tool housing, the motor being situated in the power-tool housing;
a handle fastened on the power-tool housing for guiding the hand-held power tool during operation;
a rotary motion sensor detecting a rotary motion of the power-tool housing about the working axis;
a monitor ascertaining a holding force of the user based on an amplitude of the rotary motion in a frequency range between 0.4 Hz and 4 Hz, and a safety device reducing a torque output to the tool holder when the detected rotary motion exceeds the limiting value, the limiting value being set as a function of the holding force.

7. The hand-held power tool as recited in claim 6 wherein the rotary motion sensor detects the angular velocity of the power-tool housing about the working axis.

8. The hand-held power tool as recited in claim 6 wherein the safety device compares a variable based on the angular velocity or a torsion angle of the power-tool housing with a limiting value, and the safety device increases the limiting value as the holding force increases.

9. The hand-held power tool as recited in claim 8 wherein the monitor includes a bandpass filter having the cutoff frequencies 0.4 Hz and 4 Hz.

10. The hand-held power tool as recited in claim 7 wherein the monitor includes a bandpass filter having the cutoff frequencies 0.4 Hz and 4 Hz.

11. The hand-held power tool as recited in claim 6 wherein the monitor includes a bandpass filter having the cutoff frequencies 0.4 Hz and 4 Hz.

12. A control method for a hand-held power tool including a tool holder rotationally driven about a working axis and a handle fastened on a power-tool housing for guiding the hand-held power tool during operation, the control method comprising the steps of:
detecting a rotary motion of the power-tool housing about the working axis with the aid of a rotary motion sensor;
ascertaining a holding force of the user based on an amplitude of the rotary motion in a frequency range between 0.4 Hz and 4 Hz with the aid of a monitor; and
reducing a torque output of the tool holder when the detected rotary motion exceeds a limiting value, the limiting value being set as a function of the holding force.
